(19) United States
(12) Patent Application Publication
(10) Pub. No.: US 2011/0234641 A1
(43) Pub. Date: Sep. 29, 2011

(54) DISPLAY DEVICE, DISPLAY METHOD, AND COMPUTER-READABLE RECORDING MEDIUM IN WHICH PROGRAM IS STORED

(75) Inventor: Eiji SASAKI, Tokyo (JP)

(73) Assignee: KONICA MINOLTA BUSINESS TECHNOLOGIES, INC., Tokyo (JP)

(21) Appl. No.: 13/070,919

(22) Filed: Mar. 24, 2011

(30) Foreign Application Priority Data
Mar. 24, 2010 (JP) 2010-067148

(51) Int. Cl. G09G 5/00

(52) U.S. Cl. 345/672

(57) ABSTRACT

A display device includes: a display unit that displays a screen based on display screen data including a plurality of pieces of component image data; and a control unit that causes the display unit to display an image in a display region on the display unit in a form of scroll display by which the image is moved as time advances, when a size of the image displayed on the display unit based on a first piece of the pieces of component image data is larger than a size of the display region for the image on the display unit.

### BACKGROUND OF THE INVENTION

1. Field of the Invention

The present invention relates to a display device, a display method, and a computer-readable recording medium in which a program is stored.

2. Description of the Related Art

Recently, in a multifunctional, sophisticated image forming apparatus, various images are displayed on a display unit, because of the need to inform a user of much information.

For example, in a technique disclosed in Japanese Patent Application Laid-Open Publication No. 6-19677, when, among images displayed on a display unit, there are images each of which has a size larger than a physical size of a display region for its image on a screen of the display unit, the images each of which has the size larger than the physical size are collectively stored, each of the images is divided into plural partial images, and the partial images are displayed while switched.

However, in the technique disclosed in Japanese Patent Application Laid-Open Publication No. 6-19677, it is necessary for a user to perform an operation to switch the partial images, and it is difficult for the user to recognize the image composed of the plural partial images at a glance. Thus, when there is a plurality of images each of which has a size larger than a size of a display region for its image, the display region which is set in a display area where the screen is displayed, the number of times the user performs the operation increases, so that it becomes troublesome for the user. Additionally, because improvement of the operability is also required in addition to further increase of the multifunction, the increase of the number of times the user performs the operation becomes problematic.

### SUMMARY OF THE INVENTION

In view of the foregoing, an object of the present invention is to decrease the number of times a user performs the operation and to improve the operability in displaying the image having the size larger than the display region for the image.

In order to achieve at least one object mentioned above, according to a first aspect of the present invention, there is provided a display device including: a display unit that displays a screen based on display screen data including a plurality of pieces of component image data; and a control unit that causes the display unit to display an image in a display region on the display unit in a form of scroll display by which the image is moved as time advances, when a size of the image displayed on the display unit based on a first piece of the pieces of component image data is larger than a size of the display region for the image on the display unit.

In order to achieve at least one object mentioned above, according to a second aspect of the present invention, there is provided a display method for displaying a screen based on display screen data including a plurality of pieces of component image data, the display method including: causing the display unit to display an image in a display region on the display unit in a form of scroll display by which the image is moved as time advances, when a size of the image displayed on the display unit based on a piece of the pieces of component image data is larger than a size of the display region for the image on the display unit.

In order to achieve at least an object mentioned above, according to a third aspect of the present invention, there is provided a computer-readable recording medium in which a program is stored, the program causing a computer to act as: a display unit, that displays a screen based on display screen data including a plurality of pieces of component image data; and a control unit that causes the display unit to display an image in a display region on the display unit in a form of scroll display by which the image is moved as time advances, when a size of the image displayed on the display unit based on a piece of the pieces of component image data is larger than a size of the display region for the image on the display unit.

### BRIEF DESCRIPTION OF THE DRAWINGS

The present invention will be more completely appreciated by the detailed description to be described below and the accompanying drawings. However, these are not intended to limit, the present invention, wherein:

FIG. 1 is a schematic configuration diagram of an image forming apparatus;

FIG. 2A is a view illustrating an example of an image in which an image kind is a “background image”;

FIG. 2B is a view illustrating an example of an image in which the image kind is a “screen title text”;

FIG. 2C is a view illustrating an example of an image in which the image kind is an “icon”;

FIG. 2D is a view illustrating an example of an image in which the image kind is a “button”;

FIG. 2E is a view illustrating an example of an image in which the image kind is a “button text”;

FIG. 3A is a view illustrating an example of an image in which the image kind is a “variable text” indicating an error message;

FIG. 3B is a view illustrating an example of an image in which the image kind is a “list text” indicating a job name;

FIG. 4 is a flowchart of component image data registration processing;

FIG. 5 is a flowchart of scroll selection display processing;

FIG. 6 is a view illustrating an example of a screen displayed on an LCD by display screen data; and

FIG. 7 is a schematic configuration diagram of an image forming apparatus.

### DESCRIPTION OF THE PREFERRED EMBODIMENT

Embodiments of the present invention will be described in detail with reference to the accompanying drawings.

First, a configuration of a display device according to an embodiment of the invention, will be described below.

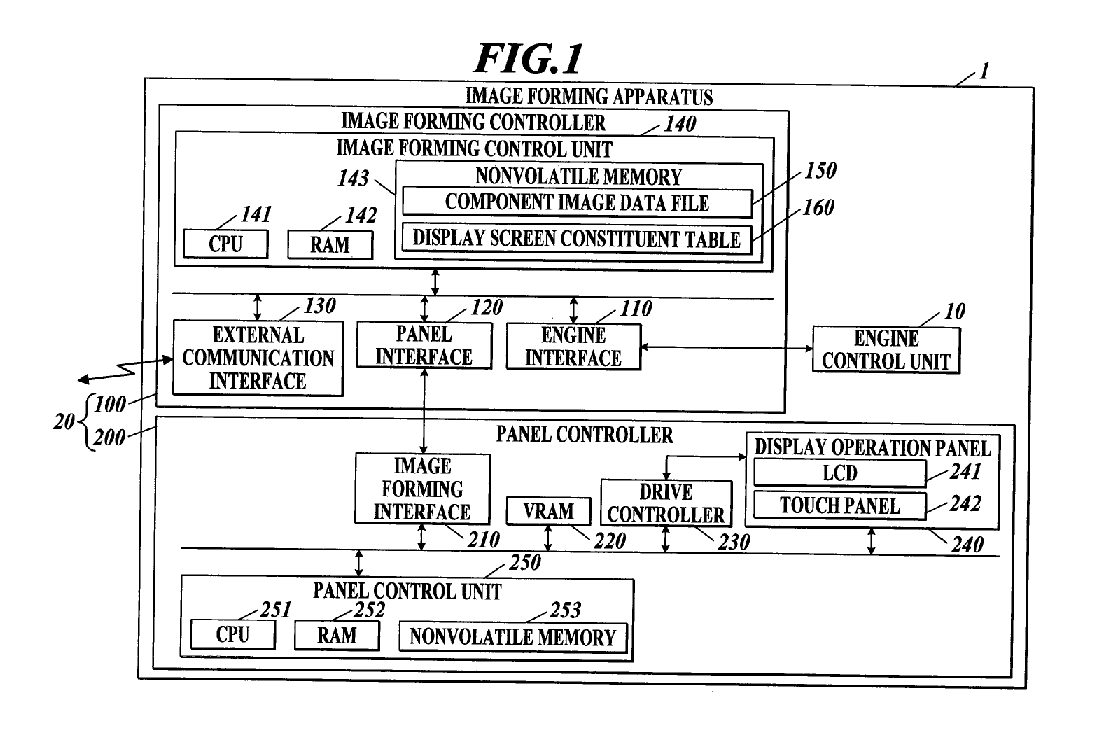

FIG. 1 is a schematic configuration diagram of an image forming apparatus 1 including a display device 20 of the embodiment.

The image forming apparatus 1 of the embodiment is used as, for example, an MFP, uses electrophotography or electrostatic recording, and has a function of forming an image based on input image data (Print function), a function of reading an original (Scan function), a function of copying the read original (Copy function), a function of recording input data in a predetermined folder (Scan to Folder function), and a transmitting and receiving function via a facsimile or an electronic mail (Fax function and Scan to E-mail function).

As illustrated in FIG. 1, the image forming apparatus 1 includes an engine control unit 10, an image forming controller 100, and a panel controller 200. The image forming controller 100 and the panel controller 200 constitute the display device 20.

The engine control unit 10 controls each unit relating to an image forming process of the image forming apparatus 1 according to a control signal input from the image forming controller 100.

Specifically, the engine control unit 10 controls each unit which performs the image forming process by the electrophotography or the electrostatic recording to perform a predetermined image forming process on input image data and to print the image data on a recording medium such as a sheet. Image data based on a print job stored in the image forming controller 100 or original image data read with a scanner (not illustrated) or the like is used as the input image data.

The image forming controller 100 includes an engine interface 110, a panel interface 120, an external communication interface 130, and an image forming control unit 140.

The engine interface 110 is a communication interface that implements a function of communication such as serial communication with the engine control unit 10. Specifically, the engine interface 110 transmits the image data based on the print job to the engine control unit 10, for example.

The panel interface 120 is a communication interface that implements a function of communication such as serial communication with the panel controller 200. Specifically, the panel interface 120 transmits and receives various pieces of data to and from the panel controller 200, for example.

The external communication interface 130 is a communication interface that implements a function of communication such as LAN (Local Area Network) communication with external devices, such as a server and a client terminal, which are connected to the image forming apparatus 1. Specifically, the external communication interface 130 receives print job data transmitted from the external devices.

The image forming control unit 140 controls each unit of the image forming apparatus 1 as a whole.

Specifically, the image forming control unit 140 controls execution of the image forming process to the input image data via the engine control unit 10, a display instruction to a display operation panel unit 240 via the panel controller 200, recording of the original image data read with the scanner (not illustrated) in a predetermined folder, facsimile transmission and reception of the original image data via a facsimile (not illustrated), an e-mail transmission and reception of the original image data via an e-mail unit (not illustrated), and the like.

The image forming control unit 140 that acts as a first control unit includes a CPU (Central Processing Unit) 141, a RAM (Random Access Memory) 142, and a nonvolatile memory 143.

The CPU 141 executes each of various programs (program codes) stored in the nonvolatile memory 143 according to a signal input from each unit of the image forming apparatus 1, and the CPU 141 outputs an output signal to each unit based on the executed program, thereby controlling the operation of the image forming apparatus 1.

The CPU 141 reads a component image data registration processing program, a scroll selection display processing program, and various pieces of necessary data from the nonvolatile memory 143. Then, the CPU 141 executes steps of processing to be performed in the image forming controller 100 with regard to the component image data registration processing and scroll selection display processing in cooperation with the read component image data registration processing program, scroll selection display processing program, various pieces of necessary data.

In the component image data registration processing, plural pieces of component image data constituting display screen data of a screen displayed on an LCD 241 of a display operation panel 240 are registered in the panel controller 200. Specifically, a component image data file 150 including plural pieces of component image data, which are previously stored in the nonvolatile memory 143, is output to the panel controller 200.

The component image data produced in displaying the screen (later-described unregistered component image data) is produced and output to the panel controller 200 when an instruction to display the screen including the image formed by using the component image data is provided.

In the component image data registration processing, a screen constituent list that is previously stored in the nonvolatile memory 143 is output to the panel controller 200.

In the component image data registration processing, a scroll display command (scroll display operation condition) is set to the component image data of which scroll display of the image is performed, and the scroll display command is output to the panel controller 200.

The image means one that is displayed on the LCD 241 using the component image data. The scroll display is a display mode in which the image is displayed while a position of the image is shifted in a continuous or stepwise manner as time advances.

The scroll display command includes a “display start command” and an “operation command”. The “display start command” includes an “initial position start command” and a “terminal start command”. One of the “initial position start command” and the “terminal start command” is set as the “display start command”. The “operation command” includes a “display region command”, a “moving direction command”, a “moving speed command”, a “basic color command”, and an “image specifying command”

The “initial position start command” indicates the start of the scroll display.

The “initial position start command” includes an instruction, when the image of which the scroll display is performed is hidden by moving out of a display region indicated by the “display region command”, to return a position of the image to a previously-set initial position in the display region for the image to resume the scroll display.

The “terminal start command” indicates the start of the scroll display.

The “terminal start command” includes an instruction, when the image of which the scroll display is performed is hidden by moving out of the display region indicated by the “display region command”, to move the image in an opposite direction to a moving direction of the image in the display region for the image so that a leading end of the image in the moving direction is disposed at a position to resume the scroll display of the image.

The “display region command” indicates coordinates (X, Y) of the region (display region) on the LCD 241 that displays the image, and a size (the number of pixels in an X-direction and the number of pixels in a Y-direction) of the display region.

The “moving direction command” indicates the moving direction of the image in the display region for the image. The “moving direction command” includes a moving amount (the number of pixels) for which the image moves in one movement. The moving amount is expressed by a positive or negative value, and by a positive or negative sign indicating an orientation in the moving direction. For example, when the moving direction is a “longitudinal direction (X-direction)” in the display region while the moving amount is “+3”, the image moves toward the positive orientation (for example, to a right direction) in the X-direction by 3 pixels in one movement. When the moving direction is a “width direction (Y-direction)” in the display region while the moving amount is “−3”, the image moves toward the negative orientation (for example, to a downward direction) in the Y-direction by 3 pixels in one movement.

The “moving speed command” indicates the moving speed of the image, that is, time intervals at which the image is re-drawn.

The “basic color command” indicates a basic color of the component image data.

The “image specifying command” indicates an identification number of the component image data based on which the image is formed, the image of which the scroll display is performed according to the “scroll display command”.

The scroll selection display processing is performed on pieces of component image data on an image kind to image kind basis.

In the scroll selection display processing, when the size of the image displayed on the LCD 241 using the component image data to which a selection instruction is set is larger than the size of the display region for the image on the LCD 241, a scroll display performing instruction for the component image data is output to the panel controller 200, the scroll display performing instruction to perform the scroll display.

In the scroll selection display processing, when the scroll display is performed on the image of another piece (second piece) of component image data whose image kind is identical to the image kind of the piece (first piece) of the component image data, the piece to which the selection instruction is set, a scroll stop command (scroll stop instruction) to stop the scroll display of the image of the second piece of component image data is output to the panel controller 200.

The scroll stop command includes a “stop command” and an “initial position stop command”

The “stop command” is an instruction to stop the image at a position within the display region at the time the image is stopped according to the scroll stop command.

The “initial position stop command” is an instruction to return the position of the image to the previously-set initial position (start position) within the display region for the image after the scroll display is stopped.

The RAM 142 includes a program storage region where various processing programs executed by the CPU 141 and the like are expanded and a data storage region where input data, processing results generated by executing the various processing programs, various pieces of setting information on the image forming controller 100, the image data based on the print job, and the like are tentatively stored.

A system program that can be executed by the image forming apparatus 1, various processing programs that can be executed by the system program, and pieces of data used to execute the various processing programs are stored in the nonvolatile memory 143. The nonvolatile memory 143 is composed of a device, such as an HDD (Hard Disk Drive) or a flash memory, in which data can be rewritten and which does not lose the stored data during power shutdown.

Specifically, the component image data registration processing program, the scroll selection display processing program, the component image data file 150 including the plural pieces of component image data which are previously-set, the display screen constituent table 160, and the like are previously stored in the nonvolatile memory 143.

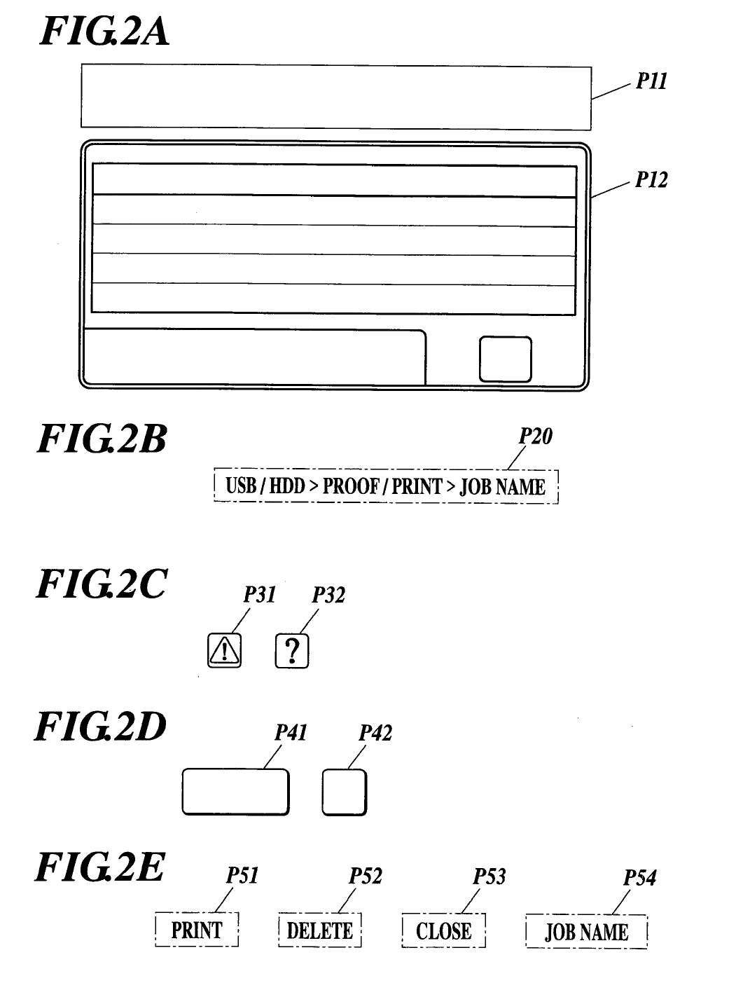

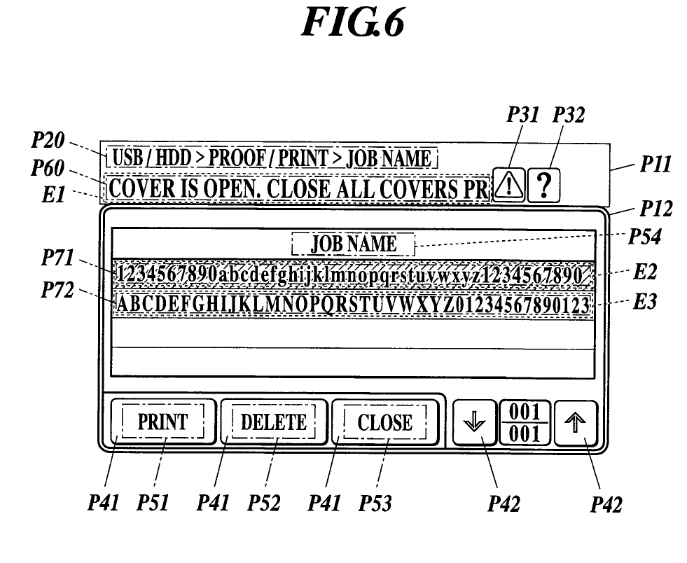

FIGS. 2A to 2E illustrate examples of the images displayed on the LCD 241 using the component image data included in the component image data file 150. The component image data included in the component image data file 150 does not change according to time passage, a state of the image forming apparatus, and the like. The images of the pieces of component image data illustrated in FIGS. 2A to 2E constitute parts of a job list screen (see FIG. 6).

FIG. 2A illustrates examples of images P11 and P12 of which an image kind is a. “background”, FIG. 2B illustrates an example of an image P20 of which the image kind is a “screen title text”, FIG. 2C illustrates examples of images P31 and P32 of which the image kind is an “icon”, FIG. 2D illustrates examples of images P41 and P42 of which the image kind is a “button”, and FIG. 2E illustrates examples of images P51 to P54 of which the image kind is a “button text”

As illustrated in FIGS. 2A to 2E, the component image data is one that relates to the images classified into plural image kinds, and each piece of the component image data constitutes a part of the display image data of the screen displayed on the LCD 241. The panel controller 200 performs processing of combining the plural pieces of component image data, thereby producing the display image data. The component image data can be sequentially obtained from the external device via an external communication interface 130, and is stored in the nonvolatile memory 143 to update/add to the data therein.

Pieces of component image data (unregistered component image data) that are images of a predetermined character string and the like exists in addition to the pieces of component image data that are previously stored in the component image data file 150 as illustrated in FIGS. 2A to 2E.

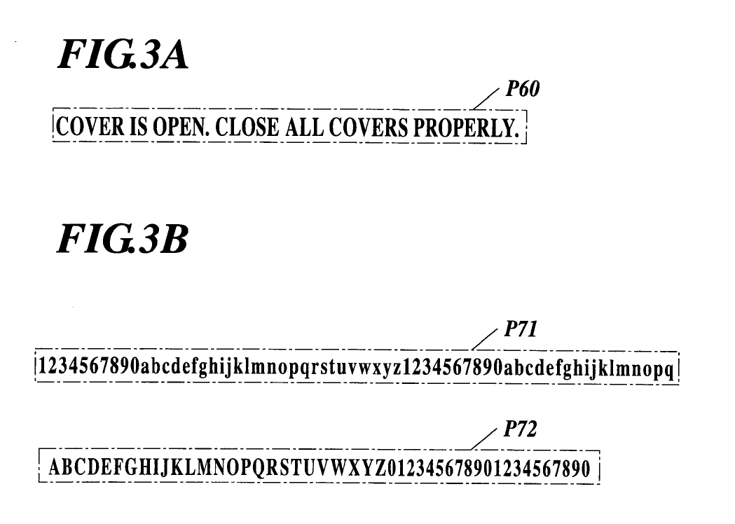

FIGS. 3A and 3B illustrate examples of the images displayed on the LCD 241 using the unregistered component image data. The images of the pieces of unregistered component image data illustrated in FIGS. 3A and 3B constitute parts of the job list screen (see FIG. 6).

FIG. 3A illustrates an example of an image P60 of which the image kind is a “variable text” indicating an error message, and FIG. 3B illustrates examples of images P71 and P72 of which the image kind is a “list text” indicating a job name.

The unregistered component image data has a nature that can sequentially change like a message according to the time passage and/or a usage mode and/or a usage status of the image forming apparatus 1. In consideration of the nature, the unregistered component image data is not included in the component image data file 150 (is not previously stored in the nonvolatile memory 143), but is produced every time a screen transition event occurs.

The component image data file 150 is one in which image information on each of pieces of the component image data is added to the respective pieces of component image data.

For example, the image information includes the image kind, the identification number, the image size, and the state.

The image kind indicates the type of the component image data (such as the “background”, the “screen title text”, the “icon”, the “button”, the “button text”, the “variable text”, and the “list text”).

The identification number is identification information that is set to each of the pieces of component image data whose image kinds are identical.

For example, as illustrated in FIG. 33, there are images each of which has the image kind of the “list text” but is expressed by a different image type. Therefore, for example, a “list text 1” is allocated to the image P71, and a “list text 2” is allocated to the image P72, in order to distinguish the different image types of the images from each other.

The image size is information expressing a size of the image of the component image data, such as a width size and a height size.

The state is information specifying the state expressed by the image of each of the various pieces of component image data.

The display screen constituent table 160 includes a state number and the screen constituent list correlated with the state number.

The state number is one that classifies the events (states) necessary to make a transition of the screen (display image data) displayed on the LCD 241. The numbers such as a “state 1”, a “state 2”, . . . are allocated to the states.

For examples, the events necessary to make the transition of the display image data include the state in which an error occurs in any one of the units of the image forming apparatus 1 and the state in which a user performs a pressing operation on the display operation panel 240.

The screen constituent list indicates a configuration of the display image data of the screen displayed on the LCD 241 when the event corresponding to each state number occurs.

Specifically, the screen constituent list indicates the information necessary for the combining processing (combining information on the combining processing) for each piece of the component image data constituting the display image data when the display image data corresponding to the state number is produced by the combining processing.

For each constituent number, an image kind, an identification number, a start position, button information, and other information are listed in the screen constituent list as list items thereof.

The constituent number is one that is allocated to each piece of component image data constituting the display image data of the screen displayed on the LCD 241, and the constituent number indicates the order in which the combining processing is performed.

The image kind is information that indicates the image kind of the component image data corresponding to the constituent number, and the image kind corresponds to the image kind included in the image information of the component image data file 150.

The identification number is information that specifies a specific type in the types of the component image data corresponding to the image kind specified by the image kind information, and corresponds to the identification number included in image information of the component image data file 150.

The start position is information which expresses the display start position on the LCD 241 by coordinates (X, Y) when the image of the component image data specified by the image kind and the identification number is displayed on the LCD 241.

The start position of the component image data is indicated by a relative position taking the start position of the component image data disposed in one layer below as an origin. Specifically, for example, when the image P41 of FIG. 2D is disposed in a layer immediately below a layer in which the image P51 of FIG. 2E is disposed, the coordinates of the start position of the image P51 become coordinate values regarding the coordinates of the start position of the image P41 as the origin (0,0).

Layer information on each piece of component image data is included in the other information described below.

The button information is one that is described when the image kind of the component image data corresponding to the constituent number is a target of the pressing operation. The button information includes information items such as an initial state, a recognition range (region specification information), and a notification presence/absence.

The initial state is information that specifies the initial state when an image is displayed on the LCD 241 in a release state, a pressing state, or the like, and the initial state corresponds to the state included in image information 161 on the component image data file 150.

The recognition range is information that indicates a range (pressing region) where the panel controller 200 recognizes that the user performs the pressing operation on the image formed by using the component image data via a touch panel 242. A starting point coordinate and an ending point coordinate of the range which is formed as a rectangular region or the like are described in the recognition range. The recognition range is not limited to the range that is substantially identical to a display region for the component image data, which is specified by the start position and the image size included in the image information of the component image data file 150, but the recognition range can be set in consideration of prevention of a false operation of the user and the usability.

The notification presence/absence is information that determines whether a predetermined pressing notification signal is transmitted to the image forming controller 100 when the user performs the pressing operation on the image formed by using the component image data via the touch panel 242.

In addition to the above-described pieces of information, various pieces of information necessary to produce the display image data are described in the other information. For example, the other information includes the layer information on the layer in which the component image data corresponding to the constituent number is disposed (information, for example, on a parent-child relationship between each piece of component image data and another piece of component image data) and character information such as a character string, a character font, a character size, and a character color of the component image data when the image kind of the component image data corresponding to the constituent number is the “character”.

The panel controller 200 includes an image forming interface 210, a VRAM (Video Random Access Memory) 220, a drive controller 230, the display operation panel 240, and a panel control unit 250.

The image forming interface 210 is a communication interface that is connected to the panel interface 120 of the image forming controller 100 via a communication cable for serial communication or the like to implement the function of the communication with the image forming controller 100.

The VRAM 220 is a video memory that is used to expand the display image data displayed on the display operation panel 240.

The drive controller 230 is an LCD controller that controls driving of the LCD 241 of the display operation panel 240 and displays the screen on the LCD 241 based on the display image data expanded on the VRAM 220.

The display operation panel 240 includes the LCD (Liquid Crystal Display) 241 and the touch panel 242.

The LCD 241 is a liquid crystal display that displays the screen based on the display image data, and acts as a display unit.

The touch panel 242 is a pressure-sensitive type (resistive film-pressure type) touch panel in which transparent electrodes are disposed in a lattice pattern on the LCD 241. The touch panel 242 detects X and Y coordinates of a force point where the pressing operation is performed with a finger, a touch pen, or the like as a voltage value, and outputs a coordinate signal expressing the detected position to the panel control unit 250. The touch panel 242 is not limited to the pressure-sensitive type touch panel, but an electrostatic type touch panel and an optical type touch panel can be used as the touch panel 242.

The panel control unit 250 includes a CPU 251, a RAM 252, and a nonvolatile memory 253. The panel control unit 250 controls the display of the display operation panel 240 based on the instruction from the image forming controller 100, and acts as a second control unit.

The CPU 251 executes each of various programs (program codes) stored in the nonvolatile memory 253 according to an input signal input from each unit of the panel controller 200, and outputs an output signal to each unit thereof based on the executed program, thereby controlling the operation of the image forming apparatus 1 as a whole.

The CPU 251 reads the component image data registration processing program, the scroll selection display processing program, the combining processing program, and various pieces of necessary data from the nonvolatile memory 253 according to the instructions input from the image forming controller 100. Then, the CPU 251 executes steps of processing to be performed in the image forming controller 200 with regard to the component image data registration processing and scroll selection display processing, and executes the combining processing, in cooperation with the read component image data registration processing program, scroll selection display processing program, combining processing program, and various pieces of data.

In the component image data registration processing, the component image data file 150 and the screen constituent list, which are input from the image forming controller 100, are stored and registered in the RAM 252 or the nonvolatile memory 253.

In the component image data registration processing, the scroll display command that is input from the image forming controller 100 is stored and registered in the RAM 252.

In the scroll selection display processing, the scroll display of the image data is performed according to the scroll display performing instruction input from the image forming controller 100 and the scroll display command registered in the RAM 252 or the nonvolatile memory 253. In the scroll selection display processing, the scroll display of the image is stopped according to the scroll stop command input from the image forming controller 100.

In the combining processing, the plural pieces of component image data are combined to produce the display image data based on the data, which is input from the image forming controller 100 by performing the component image data registration processing.

Specifically, in the combining processing, the necessary pieces of component image data are sequentially obtained from the component image data file 150 stored in the RAM 252 or the nonvolatile memory 253 in a constituent number order based on the pieces of information (from the constituent number to the other information) described in the list items of the screen constituent list, the pieces of component image data are disposed at the display start position of their respective layers in order starting from the lowest layer, and a predetermined combining process is performed to produce the display image data.

The RAM 252 includes a program storage region where various processing programs executed by the CPU 251 are expanded and a data storage region where the input data and the processing results generated in executing the various processing programs are tentatively stored.

A system program that can be executed by the panel controller 200, various processing programs that can be executed by the system program, and pieces of data used to execute the various processing programs are stored in the nonvolatile memory 253. The nonvolatile memory 253 is composed of a device, such as an HDD and a flash memory, in which the data can be rewritten and which does not lose the stored data during the power shutdown.

Specifically, the component image data registration processing program, the scroll selection display processing program, and the combining processing program are stored in the nonvolatile memory 253. The component image data file 150, the screen constituent list, and the scroll display command, all of which are input from the image forming controller 100, can be stored in the nonvolatile memory 253.

An operation according to the embodiment will be described below.

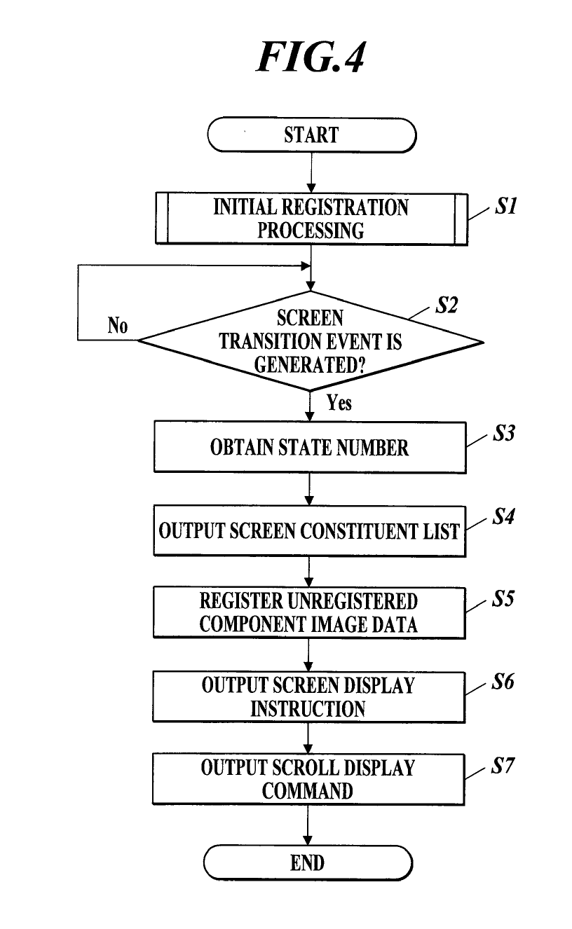

FIG. 4 is a flowchart of the component image data registration processing performed by collaboration of the CPU 141 and each unit of the image forming controller 100 of the embodiment.

The CPU 141 performs initial registration processing.

In the initial registration processing, the component image data file 150 including the plural pieces of component image data stored previously in the nonvolatile memory 143 is read, and the read component image data file 150 is output to the panel controller 200 via the panel interface 120 (Step S1).

The processing in Step S1 can be performed anytime before the screen is displayed on the LCD 241 of the display operation panel 240. For example, the processing in Step S1 can be performed when the image forming apparatus 1 is powered on.

After Step S1, the CPU 251 of the panel controller 200 stores and registers the component image data file 150 input via the image forming interface 210 in the RAM 252 or the nonvolatile memory 253.

The CPU 141 determines whether the screen transition event occurs (Step S2).

At Step S2, for example, an instruction to make the transition of the state of the screen displayed on the LCD 241 is input from the touch panel 242 of the display operation panel 240, and it is determined whether the event (screen transition event) necessary to make the transition of the display image data of the screen displayed on the LCD 241 occurs based on whether the instruction is input from the panel controller 200 via the panel interface 120.

When the screen transition event does not occur (Step S2; NO), the CPU 141 returns to Step S2. When the screen transition event occurs (Step S2; YES), the CPU 141 obtains the state number corresponding to the event from the display screen constituent table 160 (Step S3). The CPU 141 obtains the screen constituent list corresponding to the obtained state number and outputs the screen constituent list to the panel controller 200 via the panel interface 120 (Step S4).

After Step S4, the CPU 251 of the panel controller 200 stores and registers the screen constituent list input via the image forming interface 210 in the RAM 252 or the nonvolatile memory 253.

The CPU 141 produces the unregistered component image data, which is necessary for the panel controller 200 to produce the display image data by the combining processing, based on the screen constituent list obtained at Step S4, adds the image information such as the identification number to the unregistered component image data, and outputs the unregistered component image data to the panel controller 200 via the panel interface 120 (Step S5).

After Step S5, the CPU 251 of the panel controller 200 stores and registers the unregistered component image data input via the image forming interface 210 in the RAM 252 or the nonvolatile memory 253.

The CPU 141 outputs the instruction to start the execution of the combining processing according to the screen display list obtained at Step S4 and the instruction to display the screen of the display image data produced by executing the combining processing on the LCD 241 to the panel interface 200 via the panel interface 120 (Step S6).

After Step S6, the CPU 251 of the panel controller 200 reads the component image data registered in the RAM 252 or the nonvolatile memory 253 according to the screen constituent list input via the image forming interface 210, performs the combining processing to produce the display screen data, and displays the screen of the produced display screen data on the LCD 241.

The CPU 141 sets the scroll display command to each piece of component image data, of which the scroll display of the image is performed, among the pieces of component image data respectively corresponding to the identification numbers indicated by the screen constituent list obtained at Step S4, and outputs the scroll display command to the panel controller 200 via the panel interface 120 (Step S7). Then, the CPU 141 ends the component image data registration processing.

At Step S7, for example, the scroll display command including the “initial position start command” and the “operation command” is set to the image P60 illustrated in FIG. 3A, and the scroll display command including the “terminal start command” and the “operation command” is set to each of the images P71 and P72 illustrated in FIG. 3B.

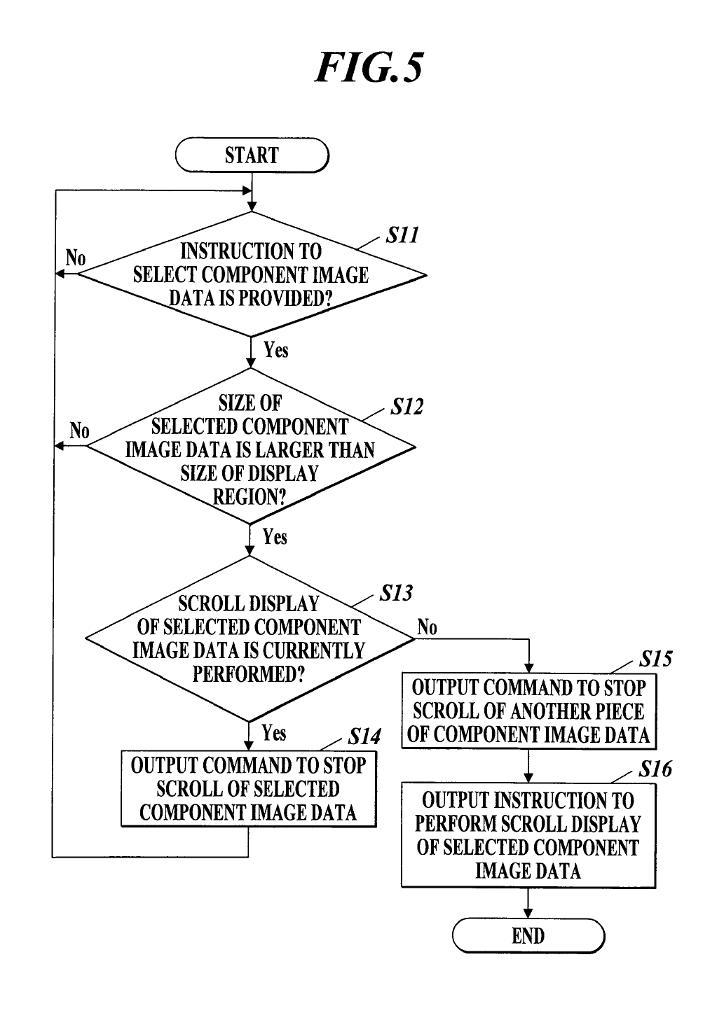

FIG. 5 is a flowchart illustrates the scroll selection display processing performed by collaboration of the CPU 141 and each unit of the image forming controller 100 of the embodiment.

When the component image data registration processing is ended, the CPU 141 refers to the screen constituent list and the scroll display command, which are output to the panel controller 200, to determine whether the selection instruction is provided to the component image data to which the scroll display command is set (Step S11).

The case in which the selection instruction is provided at Step S11 includes the case in which the initial state of the button information on the screen constituent list is a pressed state, and the case in which the pressing operation is performed via the touch panel 242.

The CPU 141 refers to the component image data file 150 to obtain the image size of the component image data to which selection instruction is provided (hereinafter referred to as selected component image data), and obtains the size of the display region from the display region command of the scroll display command of the selected component image data. The CPU 141 determines whether the image size of the selected component image data is larger than the size of the display region (Step S12).

When the image size of the selected component image data is equal to or smaller than the size of the display region (Step S12; NO), the CPU 141 returns to Step S11. When the image size of the selected component image data is larger than the size of the display region (Step S12; YES), the CPU 141 determines whether the scroll display of the image of the selected component image data is currently being performed (Step S13).

At Step S13, the CPU 141 determines that the scroll display is being performed when the scroll display performing instruction of the selected component image data is already output.

When the scroll display of the image of the selected component image data is being performed (Step S13; YES), the CPU 141 sets the scroll stop command to the selected component image data, and outputs the scroll stop command to the panel controller 200 via the panel interface 120 (Step S14), and returns to Step S11.

After Step S14, the CPU 251 of the panel controller 200 stops the scroll display of the image formed by using the selected component image data according to the scroll stop command input via the image forming interface 210.

When the scroll display of the image of the selected component image data is not being performed (Step S13; NO), the CPU 141 sets the scroll stop command to, among the pieces of component image data to each of which the scroll display command is set, a piece (second piece) of component image data whose image kind is identical to the image kind of the selected component image data (first piece of component image data), and outputs the scroll stop command to the panel controller 200 via the panel interface 120 (Step S15).

The CPU 141 outputs the scroll display performing instruction of the selected component image data to the panel controller 200 via the panel interface 120 (Step S16). Then, the CPU 141 ends the scroll selection display processing.

After Step S15, the CPU 251 of the panel controller 200 stops the scroll display of the image of the another piece of component image data whose image kind is identical to the image kind of the selected component image data according to the scroll stop command input via the image forming interface 210. After Step S16, the CPU 251 of the panel controller 200 starts the scroll display of the image of the selected component image data according to the scroll display performing instruction input via the image forming interface 210.

FIG. 6 illustrates an example of the screen displayed on the LCD 241 using the display screen data produced by the combining processing. The screen illustrated in FIG. 6 is an example of the job list screen including the images illustrated in FIGS. 2A to 2E and FIGS. 3A and 3B.

The case in which the screen of the display image data produced by the combining processing is initially displayed on the LCD 241 will be described with reference to FIG. 6.

The scroll selection display processing is performed when the screen of the display image data is initially displayed on the LCD 241. Until the scroll selection display processing is performed, the scroll display is not performed because the scroll display performing instruction is not provided to any of the pieces of component image data.

In FIG. 6, it is assumed that the scroll display command is set to each of the images P60, P71, and P72 when the screen of the display image data is initially displayed, and the scroll selection display processing is performed. It is assumed that the image sizes of the pieces of component image data of the images P60, P71, and P72 are larger than the display regions E1, E2, and E3 specified by the “display region command” of the scroll display command, respectively. It is assumed that the selection instruction is provided to each of the images P60 and P71 (the initial state of the button information is the pressed state). It is assumed that the image kind of the image P60 is the “variable text” while the image kinds of the images P71 and P72 are the “list text”.

In the image P60, the selection instruction is provided, the image size is larger than the display region E1, and the scroll display is not currently being performed. Therefore, the scroll display is started by the scroll display performing instruction.

Because the image (component image data) whose image kind is identical to the image kind of the image P60 does not exist in the job list screen illustrated in FIG. 6, the display operations of other images constituting the job list screen do not change according to the selection instruction provided to the image P60.

In the image P71, the selection instruction is provided, the image size is larger than the display region E2, and the scroll display is not currently being performed. Therefore, the scroll display is started by the scroll display performing instruction. At this point, because the image P72 whose image kind is identical to the image kind of the image P71 exists in the job list screen, the scroll display of the image P71 is stopped based on the scroll stop command.

Accordingly, the scroll display of the images P60 and P71 is performed when the job list screen illustrated in FIG. 6 is initially displayed on the LCD 241.

When the image P72 is pressed thereafter, the scroll display of the image P71 is stopped, and the scroll display of the image P72 is started. When the image P71 is pressed during the scroll display, the scroll display of the image P71 is stopped. That is, the scroll display is started or stopped according to the selection instruction by performing the scroll selection display processing.

(Modification)

In the embodiment, the image forming apparatus 1 includes the panel control unit 250 that controls the display operation panel 240. However, the invention is not limited to the image forming apparatus 1 of the embodiment. For example, it is possible that the panel control unit 250 is not included, but the image forming control unit 140 of the image forming controller 100 has a function of performing the processing which the panel control unit 20 performs.

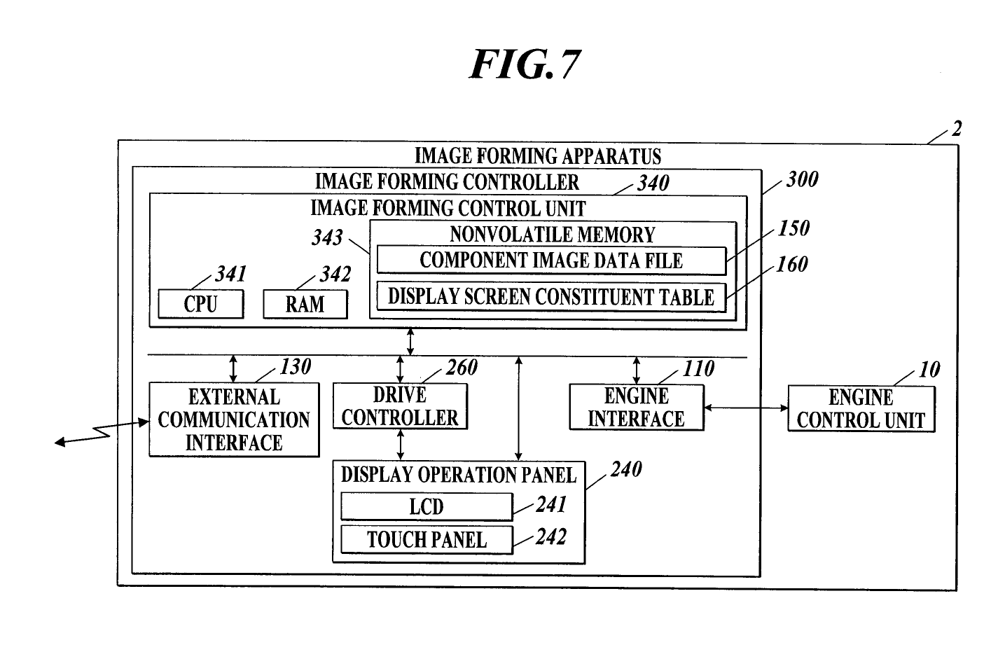

FIG. 7 is a schematic configuration diagram of an image forming apparatus 2 in which the image forming control unit 140 of the image forming controller 100 of FIG. 1 has the function of performing the processing which the panel control unit 250 performs.

The components similar to the components shown in FIG. 1 are designated by the same numerals, respectively, and the description thereof will not be repeated.

As illustrated in FIG. 7, the image forming apparatus 2 includes the engine control unit 10 and an image forming controller 300.

The image forming controller 300 includes the engine interface 110, the external communication interface 130, a drive controller 260, the display operation panel 240, and an image forming control unit 340.

The drive controller 260 is an LCD controller that controls driving of the LCD 241 of the display operation panel 240 and displays the screen on the LCD 241 based on the display image data.

The image forming control unit 340 includes a CPU 341, a RAM 342, and a nonvolatile memory 343.

The CPU 341 reads the component image data registration processing program, the scroll selection display processing program, the combining processing program, and various pieces of necessary data from the nonvolatile memory 343, and executes the component image data registration processing, the scroll selection display processing, and combining processing in cooperation with the read component image data registration processing program, scroll selection display processing program, combining processing program, and various pieces of data.

The RAM 342 includes a program storage region where various processing programs executed by the CPU 341 are expanded and a data storage region where input data, processing results generated in executing the various processing programs, various pieces of setting information on the image forming controller 300, and the image data based on the print job, and the like are tentatively stored.

A system program that can be executed by the image forming apparatus 2, various processing programs that can be executed by the system program, and pieces of data used to execute the various processing programs are stored in the nonvolatile memory 343, for example. The nonvolatile memory 343 is composed of a device, such as a HDD and a flash memory, in which the data can be rewritten and which does not lose the stored data during the power shutdown.

Specifically, the component image data registration processing program, the scroll selection display processing program, the combining processing program, the component image data file 150 including the plural pieces of component image data which are previously-set, the display screen constituent table 160, and the like are previously stored in the nonvolatile memory 343.

An operation in the modification will be described below.

In the component image data registration processing of the modification, since the image forming control unit 340 performs the combining processing, among the steps of processing in the component image data registration processing of FIG. 4, the steps of processing except the step of processing of outputting the component image data file 150, the screen constituent list, the scroll display command, and, and the like to the panel controller 200 are taken.

The CPU 341 determines whether the screen transition event occurs.

When the screen transition event does not occur, the CPU 341 waits until the screen transition event occurs. When the screen transition event occurs, the CPU 341 obtains the state number corresponding to the event from the display screen constituent table. Then, the CPU 341 obtains the screen constituent list corresponding to the obtained state number.

The CPU 341 produces the unregistered component image data, which is necessary to produce the display image data by the combining processing, based on the obtained screen constituent list, and adds the image information such as the identification number to the unregistered component image data.

The CPU 341 starts the execution of the combining processing according to the obtained screen display list, and outputs the instruction to display the screen of the display image data, produced by performing the combining processing, on the LCD 241 to the drive controller 260.

The CPU 341 sets the scroll display command to each piece of component image data, of which the scroll display of the image is performed, among the pieces of component image data respectively corresponding to the identification numbers indicated by the obtained screen constituent list. Then, the CPU 341 ends the component image data registration processing.

In the combining processing of the modification, the necessary pieces of component image data are sequentially obtained from the component image data file 150 in the constituent number order based on the pieces of information (from the constituent number to the other information) described in the list items of the obtained screen constituent list, the pieces of component image data are disposed at the display start position of their respective layers in order starting from the lowest layer, and a predetermined combining process is performed to produce the display image data.

In the scroll selection display processing of the modification, since the image forming control unit 340 performs the start and the stop of the scroll display, among the steps of processing in the scroll selection display processing of FIG. 5, the steps of processing except the step of processing of outputting the scroll stop command, the scroll display performing instruction, and the like to the panel controller 200 are taken.

In the scroll selection display processing of the modification, when the component image data registration processing is ended, the CPU 341 refers to the obtained screen constituent list and the set scroll display command to take the steps of processing identical to Steps S11 to S13 illustrated in FIG. 5.

When the scroll display of the image of the selected component image data is being performed, the CPU 341 sets the scroll stop command to the selected component image data, and stops the scroll display of the image formed by using the selected component image data according to the scroll stop command.

When the scroll display of the image of the selected component image data is not being performed, the CPU 341 sets the scroll stop command to, among the pieces of component image data to each of which the scroll display command is set, a piece (second piece) of component image data whose image kind is identical to the image kind of the selected component image data (first piece of component image data), and stops the scroll display of the image formed by using the second piece of component image data whose image kind is identical to that the image kind of the selected component image data.

The CPU 341 sets the scroll display performing instruction to the selected component image data, and starts the scroll display of the image formed by using the selected component image data according to the scroll display performing instruction.

As described above, according to the embodiment, because the image of the component image data having the size larger than the size of the display region can be displayed in the display region by performing the scroll display, the image having the image size larger than the size of the display region can be displayed without the user operation. Consequently, the number of times the user performs the operation to display the image can be decreased, and the operability can be improved.

Furthermore, when the display device 20 has the configuration illustrated in FIG. 1, a control load of the scroll display can be spread between the image forming control unit 140 and the panel control unit 250. Consequently, the screen display processing speed can be improved.

The scroll display of the image of the component image data to which the selection instruction is provided can be performed, and the scroll display of the image of another piece of component image data whose image kind is identical to the image kind of the selected component image data can be stopped. Therefore, when the pieces of component image data having the identical image kind exist, the scroll display of only the image of the selected component image data can be performed.

When the scroll stop command is the “initial position stop command”, the image can be returned to the previously-set initial position in the display region for the image after the scroll display of the image is stopped.

In a case where the scroll display command includes the “initial position start command”, the image can be returned to the previously-set initial position in the display region for the image to resume the scroll display, when the image is hidden by moving out of the display region due to the scroll display.

In a case where the scroll display command includes the “terminal start command”, the image can be moved in the opposite direction to the moving direction of the image in the display region for the image so that a leading end of the image in the moving direction is disposed at a position to resume the scroll display, when the image is hidden by moving out of the display region due to the scroll display.

The scroll display of the image can be performed at the moving speed indicated by the “moving speed command” in the moving direction indicated by the “moving direction command” of the scroll display command.

In the above description, by way of example, the nonvolatile memories 143, 253, and 343 are used as the computer-readable recording medium for the programs of the invention. The invention is not limited to the nonvolatile memories 143, 253, and 343. For example, a nonvolatile memory such as a flash memory and a portable recording medium such as a CD-ROM can be used as the computer-readable recording medium.

A carrier wave can also be used as a medium that provides the data of the programs of the invention via a communication line.

The invention is not limited to the embodiment and the modification, and hence can appropriately change without departing from the scope of the invention.

A first aspect of a preferred embodiment of the invention provides a display device includes: a display unit that displays a screen based on display screen data including a plurality of pieces of component image data; and a control unit that causes the display unit to display an image in a display region on the display unit in a form of scroll display by which the image is moved as time advances, when a size of the image displayed on the display unit based on a first piece of the pieces of component image data is larger than a size of the display region for the image on the display unit.

A second aspect of a preferred embodiment of the invention provides a display method for displaying a screen based on display screen data including a plurality of pieces of component image data, the display method including: causing the display unit to display an image in a display region on the display unit in a form of scroll display by which the image is moved as time advances, when a size of the image displayed on the display unit based on a piece of the pieces of component image data is larger than a size of the display region for the image on the display unit.

A third aspect of a preferred embodiment of the invention provides a computer-readable recording medium in which a program is stored, the program causing a computer to act as: a display unit that displays a screen based on display screen data including a plurality of pieces of component image data; and a control unit that causes the display unit to display an image in a display region on the display unit in a form of scroll display by which the image is moved as time advances, when a size of the image displayed on the display unit based on a piece of the pieces of component image data is larger than a size of the display region for the image on the display unit.

In the display device, the display method, and the computer-readable recording medium in which the program is stored, the image whose size is larger than the size of the display region can be displayed without the user operation. Consequently, the number of times the user performs the operation to display the image can be decreased, and the operability can be improved.

Preferably, the control unit includes: a first control unit; and a second control unit that causes the display unit to display the screen based on the display screen data according to an instruction from the first control unit, the first control unit outputs a scroll display operation condition for the first piece of component image data of which the scroll display of the image is performed to the second control unit, the first control unit outputs a scroll display performing instruction for the first piece of the component image data to the second control unit, when the size of the image displayed on the display unit based on the first piece of component image data is larger than the size of the display region for the image on the display unit, and the second control unit causes the display unit to perform the scroll display of the image based on the scroll display operation condition and the scroll display performing instruction, which are inputted from the first control unit.

Accordingly, the control load of the scroll display can be spread between the first control unit and the second control unit.

Preferably, the display device includes an input unit to which a selection instruction to select a piece from among the pieces of component image data included in the display screen data is input, wherein the first control unit outputs the scroll display performing instruction for the first piece of component image data to the second control unit, when the size of the image displayed on the display unit based on the first piece of component image data indicated by the selection instruction inputted from the input unit is larger than the size of the display region for the image on the display unit.

Accordingly, the scroll display of the image of the selected component image data can be performed.

Preferably, the pieces of component image data are previously classified into a plurality of kinds, the first control unit outputs a scroll stop instruction to stop the scroll display of an image of a second piece of the component image data to the second control unit, when the scroll display of the image of the second piece of component image data is performed, the second piece of which a kind is identical to a kind of the first piece of the component image data indicated by the selection instruction inputted from the input unit, and the second control unit stops the scroll display of the image of the second piece of component image data based on the scroll stop instruction inputted from the first control unit.

Accordingly, because the scroll display of the image of the second piece of component image data whose kind is identical to the kind of the selected component image data (first piece of component image data) can be stopped, the scroll display of only the image of the selected component image data can be performed when the pieces of component image data having the identical kind exist.

Preferably, the scroll stop instruction includes an instruction to return the image to a previously-set initial position in the display region for the image after the scroll display of the image is stopped.

Accordingly, the image can be returned to the previously-set initial position in the display region for the image after the scroll display of the image is stopped.

Preferably, the scroll display operation condition includes an instruction to return the image to a previously-set initial position in the display region for the image to perform the scroll display, when the image is hidden by moving out of the display region for the image.

Accordingly, the image can be returned to the previously-set initial position in the display region for the image to resume the scroll display when the image is hidden by moving out of the display region due to the scroll display.

Preferably, the scroll display operation condition includes an instruction to move the image in an opposite direction to a moving direction of the image in the display region for the image so that a leading end of the image in the moving direction is disposed at a position so as to perform the scroll display of the image, when the image is hidden by moving out of the display region for the image.

Accordingly, the image can be moved in the position in the opposite direction to the moving direction of the image in the display region for the image so that the leading end of the image in the moving direction is disposed at a position to perform the scroll display, when the image is hidden by moving out of the display region due to the scroll display.

Preferably, the scroll display operation condition includes a moving direction of the image.

Accordingly, the scroll display of the image can be performed in the moving direction included in the scroll display operation condition.

Preferably, the scroll display operation condition includes a moving speed of the image.

Accordingly, the scroll display of the image can be performed at the moving speed included in the scroll display operation condition.

This application is based on and claims the benefit of priority from Japanese Patent. Application No. 2010-067148, filed in the Japan Patent Office on Mar. 24, 2010, the entire contents of which are incorporated herein by reference.

What is claimed is:

1. A display device comprising:
a display unit that displays a screen based on display screen data including a plurality of pieces of component image data; and
a control unit that causes the display unit to display an image in a display region on the display unit in a form of scroll display by which the image is moved as time advances, when a size of the image displayed on the display unit based on a first piece of the pieces of component image data is larger than a size of the display region for the image on the display unit.

2. The display device according to claim 1, wherein
the control unit includes:
a first control unit; and
a second control unit that causes the display unit to display the screen based on the display screen data according to an instruction from the first control unit,
the first control unit outputs a scroll display operation condition for the first piece of component image data of which the scroll display of the image is performed to the second control unit,
the first control unit outputs a scroll display performing instruction for the first piece of the component image data to the second control unit, when the size of the image displayed on the display unit based on the first piece of component image: data is larger than the size of the display region for the image on the display unit, and
the second control unit causes the display unit, to perform the scroll display of the image based on the scroll display operation condition and the scroll display performing instruction, which are inputted from the first control unit.

3. The display device according to claim 2 further comprising:
an input unit to which a selection instruction to select a piece from among the pieces of component image data included in the display screen data is input, wherein
the first control unit outputs the scroll display performing instruction for the first piece of component image data to the second control unit, when the size of the image displayed on the display unit based on the first piece of component image data indicated by the selection instruction inputted from the input unit is larger than the size of the display region for the image on the display unit.

4. The display device according to claim 3, wherein.
the pieces of component image data are previously classified into a plurality of kinds,
the first control unit outputs a scroll stop instruction to stop the scroll display of an image of a second piece of the component image data to the second control unit, when the scroll display of the image of the second piece of component image data is performed, the second piece of which a kind is identical to a kind of the first piece of the component image data indicated by the selection instruction inputted from the input unit, and
the second control unit stops the scroll display of the image of the second piece of component image data based on the scroll stop instruction inputted from the first, control unit.

5. The display device according to claim 4, wherein the scroll stop instruction includes an instruction to return the image to a previously-set initial position in the display region for the image after the scroll display of the image is stopped.

6. The display device according to claim 2, wherein the scroll display operation condition includes an instruction to return the image to a previously-set initial position in the display region for the image to perform the scroll display, when the image is hidden by moving out of the display region for the image.

7. The display device according to claim 2, wherein the scroll display operation condition includes an instruction to move the image in an opposite direction to a moving direction of the image in the display region for the image so that a leading end of the image in the moving direction is disposed at a position so as to perform the scroll display of the image, when the image is hidden by moving out of the display region for the image.

8. The display device according to claim 2, wherein the scroll display operation condition includes a moving direction of the image.

9. The display device according to claim 2, wherein the scroll display operation condition includes a moving speed of the image.

10. A display method for displaying a screen based on display screen data including a plurality of pieces of component image data, the display method comprising:
causing the display unit to display an image in a display region on the display unit in a form of scroll display by which the image is moved as time advances, when a size of the image displayed on the display unit based on a piece of the pieces of component image data is larger than a size of the display region for the image on the display unit.

11. A computer-readable recording medium in which a program is stored, the program causing a computer to act as:
a display unit that displays a screen based on display screen data including a plurality of pieces of component image data; and
a control unit that causes the display unit to display an image in a display region on the display unit in a form of scroll display by which the image is moved as time advances, when a size of the image displayed on the display unit based on a piece of the pieces of component image data is larger than a size of the display region for the image on the display unit.
